(19) United States
(12) Patent Application Publication
(10) Pub. No.: US 2026/0284706 A1
(43) Pub. Date: Sep. 24, 2026

(54) SCREENING, CRUSHING OR MIXING ARRANGEMENT FOR HEAVY EQUIPMENT

(71) Applicant: ALLU INNOVATION AND RESEARCH CENTER OY, Pennala (FI)

(72) Inventor: Markku JONNINEN, Lohilahti (FI)

(73) Assignee: ALLU INNOVATION AND RESEARCH CENTER OY, Pennala (FI)

(21) Appl. No.: 19/472,450

(22) PCT Filed: Feb. 28, 2024
(86) PCT No.: PCT/FI2024/050073

§ 371 Date: Oct. 3, 2025

(30) Foreign Application Priority Data
Apr. 21, 2023 (FI) 20235446

(51) Int. Cl. B07B 1/15; B02C 23/08

(52) U.S. Cl. CPC B07B 1/15; B02C 23/08

(57) ABSTRACT

A screening, crushing or mixing blade arrangement for heavy equipment includes screen plates forming a screen surface with screen slots. A blades are installed on each shaft. Blades have a non-circular mounting hole essentially corresponding to the shaft cross-section. A first blade element, when being installed, can be brought to a desired location on the shaft through its installation opening, and a second blade element can be brought onto shaft from the opposite direction to the first blade element next to the first blade element through its installation opening. The blade elements can be brought into alignment with each other in the longitudinal direction of shaft by longitudinal movement of shaft. The edges of the installation openings comprise locking designs forming the locking between the installed first blade element and the second blade element in the opposite direction in relation to the longitudinal direction of shaft.

The object of the present invention is a screening, crushing or mixing blade arrangement for heavy equipment, comprising a plurality of screen plates at a distance from each other and forming a screen surface provided with screen slots, one or more non-circular rotatable shafts and power transmission members for rotating the shafts, having mounted thereon several replaceable, freely movable blades in the longitudinal direction of the shaft, which blades are mounted directly on the shaft and extending in the radial direction of the shaft outwards from the shaft through screen slots, the blades having a non-circular mounting hole essentially corresponding to the cross-section of the shaft.

The arrangement according to the invention is suitable for use, for example, in connection with the screen arranged in the bucket of the heavy equipment disclosed in publication DE202006001257 U1, which screen is particularly suited for soil screening. The equipment can be e.g. an excavator, wheel loader, telehandler or other suitable mobile machine. The equipment can also be a screening, crushing and/or mixing device designed for this purpose, which can be stationary or movable. The screen comprises a screen surface equipped with slots, below which there are rotatable shafts with a polygonal cross-section, having mounted thereon projecting blades rotating with the shafts and extending through the slots of the screen surface above the screen surface. The blades can be moved axially along the respective shafts and replaceable by disassembling the shafts from the screen and then removing the replaceable blades from the shafts and installing new blades in their place.

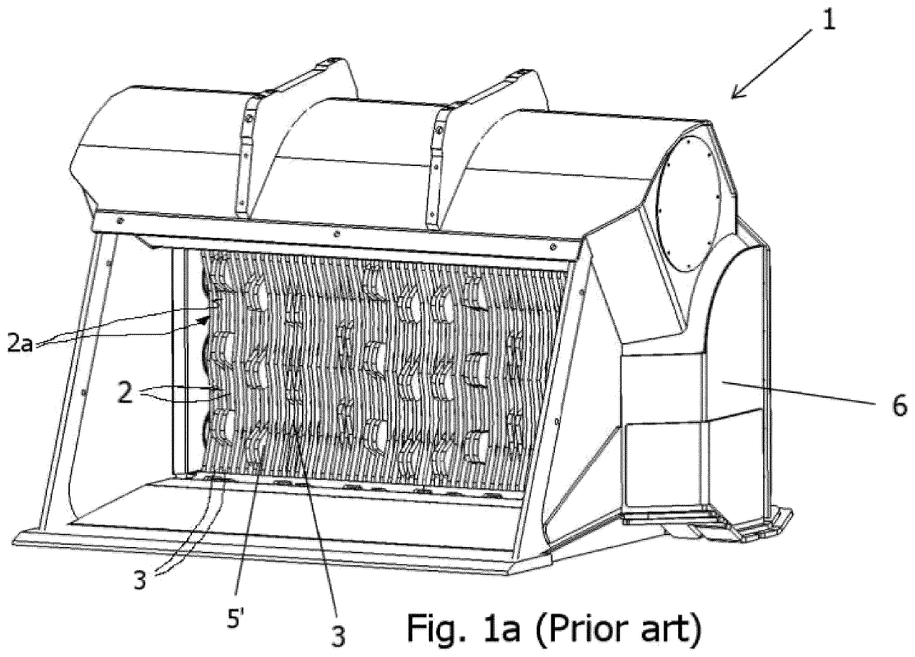

Shown schematically in FIGS. 1a and 1b is a prior art screening arrangement mounted on the bucket 1 of a mobile heavy equipment, for which the arrangement according to the invention is suitable for use. The arrangement in question relates to the arrangement disclosed in the applicant's own Finnish patent 128813 B, blades 5′ attached onto rotating shaft 4. The arrangement includes screening surface 2a arranged in the loading space inside bucket 1, with slots that determine the coarse-ness of screening. Screening surface 2a is therefore formed by the front surfaces of adjacent screen plates 2. Behind the screen surface (FIG. 1b) there are rotatable shafts 4, having arranged thereon blades 5′ extending outward from shaft 4 in the radial direction, which in the installed state of screen plates 2 extend through the slots (screen slots 3) of the screen surface. This can be seen especially in FIG. 1a and FIG. 1b as blades 5′ extending past (behind) rear surfaces 2c of the screen plates 2. Blade 5′ in itself comprises a mounting hole 8, which is discontinuous on its inner surface, whereby it has an installation opening, through which the blade can in turn be brought onto the shaft through the thinned section formed in the shaft and slid to the desired position in the longitudinal direction of the shaft. Here, too, changing the blade requires a relatively large amount of disassembly work and specific shaping of the shaft, for example the thinned section mentioned above.

Corresponding screening arrangements are also used in e.g., screen crushers, in which special crushing blades are used, and in mixers, in which special mixing blades are used.

In these prior art solutions, changing the blades requires a relatively large amount of dismantling, special shaping of the shafts and/or detaching the shafts from the bucket or the body of the specially designed equipment, which is a relatively laborious task, because the power transmission equipment must first be dismantled and then the shaft can be detached from the bucket or the body of the equipment. This is difficult especially in worksite conditions.

The aim of the present invention is to provide a solution with which the workload required for changing the blades can be significantly reduced and whereby changing the blades can also be carried out in worksite conditions without hoisting aids.

An objective is also to provide a solution that can be used in existing shaft arrangements. The purpose is also to enable screening or crushing of soil or other similar material into different grain sizes, including fine grain sizes.

In order to achieve this goal, the arrangement according to the invention is characterized in that blade is formed from two separate blade elements, wherein the first blade element and the second blade element of blade comprise respective installation openings opening outwards in the radial direction of the mounting hole, that the first blade element is dimensioned so that, when being installed, it can be brought to the desired location on the shaft through its installation opening and the second blade element can be brought onto the shaft from the opposite direction with respect to the first blade element next to the first blade element through its installation opening, that the first blade element and the second blade element can be brought into alignment with each other in the longitudinal direction of shaft by a longitudinal movement of shaft, and that the edges of the installation openings comprise locking design forming the locking between the installed first blade element and the second blade element in the direction transverse to the longitudinal direction of the shaft.

In the following, the invention is described in more detail with reference to the ac-companying drawings, in which:

FIG. 1a shows a schematic view of a prior art screen bucket and its blades viewed from the front,

FIG. 1b shows the screen bucket according to FIG. 1a seen from behind,

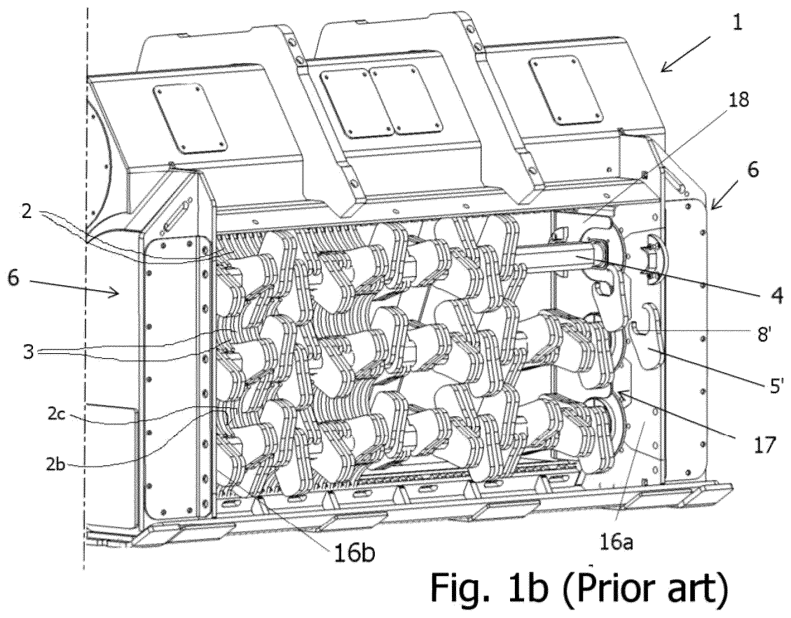

FIG. 2a shows the blade according to a preferred embodiment of the invention, the blade elements of which being detached from each other,

FIG. 2b shows the blade shown in FIG. 2a, the blade elements of which being joined together,

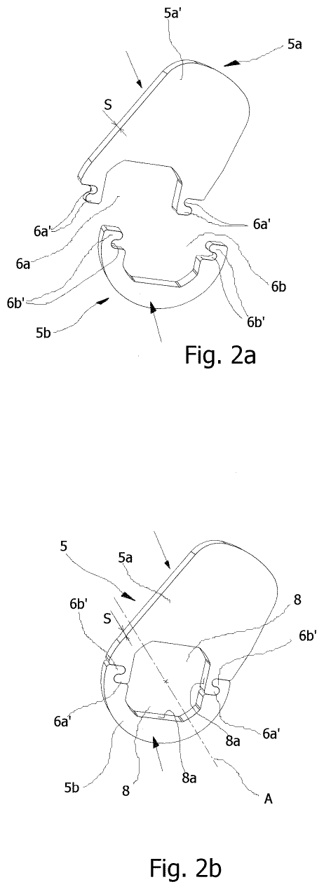

FIG. 3 shows blades according to another preferred embodiment of the invention, which are in the form of a screening disk and attached to the screen plates forming the screen slot, and

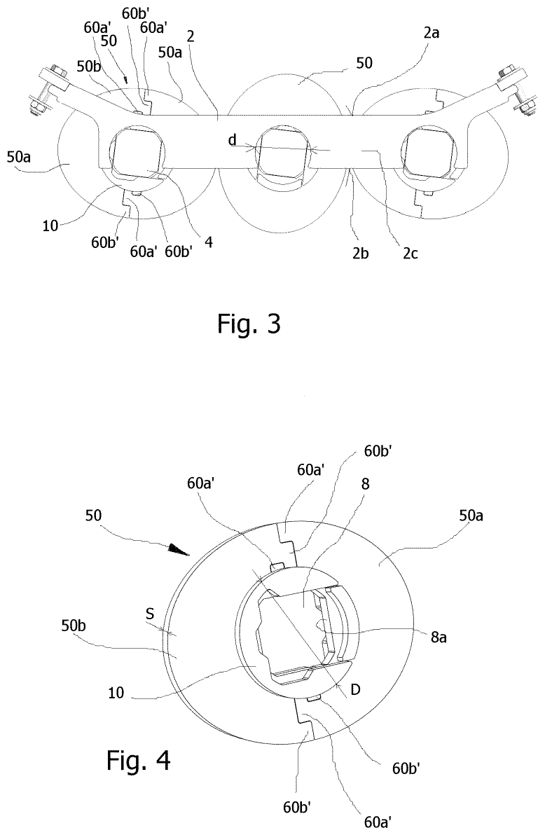

FIG. 4 shows a screening disk as shown in FIG. 3, equipped with a flanged shoulder.

Shown in FIG. 1 is a prior art screen bucket arranged in the bucket of a mobile heavy equipment, being described in more detail above in the preamble. The features shown in FIG. 1, which are related to the applicant's previous patent FI 128813 B, with the exception of the blade and its structure, can be included in the teachings of the preferred embodiment presented below. Corresponding features are also disclosed in the aforementioned publication DE202006001257 U1. It should also be noted here that the arrangement can also be applied directly to the blade arrangement of heavy equipment intended for screening, crushing or mixing.

FIG. 1 shows, as a schematic diagram, one embodiment of the arrangement according to the invention, depicting a screening blade assembly arranged on three shafts 4. The assembly is arranged in screen space 17 between the inner side walls 16a, 16b of the bucket body. Shafts 4 extend between said space and also part of their length to the power transmission equipment, not necessary to show here, arranged inside housing 6. FIG. 1 also shows mudguard 18, which is described in more detail in the applicant's European patent EP2216448B1. The mudguard can also be omitted in the arrangement according to the present invention.

A preferred embodiment of blade 5 belonging to the arrangement is shown in more detail in FIGS. 2a and 2b. In the shown embodiment, blade 5 is formed as a plate-like screening blade and has a mounting hole 8 extending in the thickness direction S, having a shape of inner surface 8a corresponding to the cross-sectional shape of shaft 4. Thickness S of blade 5 is preferably dimensioned to essentially correspond to the width of screen slot 3. Accordingly, screen slot 3 is formed between two adjacent screen plates 2, as shown in FIGS. 1a and 1b. The width of screen slot 3 can be, for example, 0.1 to 1 mm greater than thickness S of the blade, in which case blade 5, when installed on shaft 4, remains in the screen slot 3 formed between the two screen plates 2. Two or more blades 5 can also be arranged in parallel in the correspondingly enlarged slot between the two screen plates.

Mounting hole 8 is made discontinuous in the direction of the circumference of its inner surface 8a by forming the blade 5 at the mounting hole 8 into two blade elements. In FIG. 2a, the blade elements are shown detached from each other. The first blade element is marked with reference number 5a and the second blade element is marked with reference number 5b. The first blade element 5a comprises installation opening 6a opening outwards in the radial direction of mounting hole 8. Here, blade element 5a also comprises the actual blade part 5a′ (FIG. 2a), which extends through the screen surface of screen slot 3 to the other side (upper side), i.e. the front side. Here, the front side (and the front surface) refers to the side that supplies soil or similar material. Correspondingly, the second blade element 5b comprises a corresponding mounting opening 6b that opens outwards in the radial direction of mounting hole 8. Blade elements 5a and 5b are preferably divided from mounting hole 8 into parts such that inner surface 8a of mounting hole 8 is divided into two parts of the same shape and size.

The edges of installation openings 6a and 6b comprise corresponding locking designs 6a′, 6b′ forming the locking between the first blade element 5a and the second blade element 5b installed in place and aligned in the manner shown below and described in FIG. 2b in a direction transverse to the longitudinal direction of shaft 4. In other words, this locking of blade 5 prevents blade elements 5a and 5b from detaching from each other in the radial direction of shaft 4 when the forces caused by its rotation are imposed on blade 5. Here, the locking designs form pairs of locking designs which are located on essentially opposite sides, preferably on opposite sides of shaft 4.

Blade 5 can be removed from shaft 4 by simply removing enough screen plates 2 from between blades 5 to enable sliding of blade elements 5a and 5b of blade 5 out of locking in the direction of shaft A (FIG. 2b), i.e. relative to each other to a position where they are non-aligned in the direction of shaft A. Consequently, both blade elements 5a and 5b can be detached in the radial direction and, for example, replaced.

The detachable screen plates 2 (screens) can consist of one large element, smaller element packages that form the screen surface 2a, or individually replaceable screen plates, i.e. screen battens. Blades 5 locked around shafts 4 in the gaps or screen slots 3 of screen plates 2 can move freely in the longitudinal direction A of shaft 4 between screen plates 2. The gap or screen slot 3 must be so small that in any position when forces are applied to blade 5, the space formed by the combination of clearances and deflections does not allow blades 4 to unlock.

Installation of the blade in place around shaft 4 takes place accordingly by removing, usually in connection with the replacement of the aforementioned blade 5, the screen plates 2 between blades 5 so that blade elements 5a and 5b of blade 5 can be brought in the longitudinal direction A of shaft 4 directly to the desired position. In this case, for example, the first blade element 5a is brought through its installation opening 6a from one side of shaft 4 around the shaft, and the second blade element 5b is brought from the opposite side of shaft 4 in the longitudinal direction A of shaft 4 beside the first blade element 5a. In this case, the second blade element 5b can be slid along shaft 4 in the direction of the arrow shown in FIG. 2a to align at the position shown in FIG. 2b. It is not essential which of the blade elements is taken to shaft 4 first and which blade element is moved. What is essential here is the relative movement of the blade elements in the longitudinal direction A of the shaft. Consequently, locking designs 6a′ and 6b′ formed on blade 5 also come into alignment, forming the above-described locking between blade elements 5a and 5b. After this, the detached screen plates 2 can be fixed in place on both sides of blade 5. In this case, the blade elements rest on their opposite sides of the side walls 2c of screen plates 2, whereby blade elements 5a and 5b and thus the entire blade 5 are also locked in place in the longitudinal direction A of shaft 4.

Locking designs 6a′ and 6b′ are shown in FIGS. 2a and 2b as curved surfaces that are placed against each other when blade elements 5a and 5b are brought by sliding them along the shaft together to form blade 5. In this case, the curved surfaces rest against each other and prevent the movement of blade elements 5a and 5b relative to each other in the radial or rotational direction of shaft 4. In such a load condition, due to the shape of the locking designs, the blade elements merely lock together more firmly. Locking designs can have other shapes in addition to or instead of curved surfaces, in which case the designs can be, for example, chamfered surfaces or flat surfaces. If necessary, these designs can be shaped so that in a load condition the blade elements tend to adjust themselves between screen plates 2.

The cross-section of shaft 4 and the corresponding design of inner surface 8a of mounting hole 8 are preferably made so that blade 5 can be placed in different angular positions with respect to shaft 4 along the circumferential dimension of the shaft, and the shape is locked in place against rotation in the manner described above. Mounting hole 8 forms a uniform part of the inner surface 8a along the entire length of the circumference, ensuring that blade 5 stays on shaft 4.

Shown in FIGS. 3 and 4 is a blade according to another embodiment of the invention, marked with reference number 50 and positioned in a similar way between screen plates 2. This is blade 50, which is formed from two blade elements 50a and 50b, respectively. Here, however, the actual blade part 50a, which extends in the radial direction of shaft 4 outwards from the shaft through the screen slots, is formed in both blade elements. Owing to the semi-oval shape of blade elements 50a and 50b, blade 50, when combined, forms a well-known screening disk, which has an oval shape on its outer circumference. FIG. 3 shows an arrangement in which the rotation angle of the long and short shafts of the screening disk 50 of successive ovals is 90 degrees rotated relative to each other. The shape is not limited to the oval shape, but can be something else, such as the shape of a star or other polygon. Such a screening disk 50 can be compared in function and structure to blade 5 according to the first embodiment.

Screening disk 50 also has the corresponding installation openings and locking designs 60a′ and 60b′ as presented in connection with the first embodiment, whereby they can be brought in a fully similar way on shaft 4 into connection with each other. In FIGS. 3 and 4, there are no reference numbers for the installation openings, but they can be recognized from the figures on the basis the teachings of the first embodiment. In the following, an example will be shown of an application where screening disks are used either instead of or in addition to blade 5 according to the first embodiment.

When screening of fine fractions is desired, such as a grain size of only a few millimeters, the traditional fixed screen slot 3 of screen plates 2 determining the lump size leads to the fact that the thickness of the rotating blade becomes so small that the locking, when divided into two parts in this way, may no longer work due to practical clearances and deflections. The solution to this is that the distance between the fixed screen plates 2 is increased and between them a rotating “screen line” formed by screening disks 50 is formed, in this case formed from oval disks. In this case, the major and minor axes of the oval disks, which are in the same position around the adjacent shafts and divided into two parts, are at an angle of 90 degrees to each other. When the shafts rotate synchronously with respect to each other in the same direction, the rotating oval screening disks form a moving “screen” in the screen slots 3 of fixed screen plates 2, and locking of the blades is performed by a joint that locks around shafts 4, as already explained. If thickness S of these oval screening disks 50 or i.e. the width in the direction of the shaft is, for example, 10 mm and the desired screen size is 5 mm, then the distance between the fixed screens (screen plates 2) would be at least 20 mm+rotation clearances (shown above). In this case, the width of the locking surface can be implemented around shafts 4 in the form of a circle also as a divided adapter 10 as part of the screening disk 50. Here, adapter 10 is in the form of a flanged shoulder. Diameter D of flanged shoulder 10 is large enough to provide axial locking between the fixed screen plates 2 for blade elements 50a and 50b of screening disk 50. A diameter D that is a few millimeters larger than the smallest diameter d of the fixed screen around axis 4 is usually sufficient. The dimensions mentioned above are only examples of possible dimensions. They can be something else depending, for example, on the desired grain size and taking into account the robustness of the arrangement.

The sides of these oval disks can also be provided with projections, which help to keep screen slots 3 or gaps of screen plates 2 clean and improve the movements of the material over the screening surface.

Screening disks 50 can also be designed in terms of locking so that only one similar screening disk 50 can be used on both sides by making the locking (locking designs) of the other side a mirror image. This reduces the need for consumable parts, because the same part fits with both halves.

In general, it is also important that the screen slot 3 formed by screen plates 2 and thus rear surfaces 2b and front surfaces of screen plates 2, i.e. screen surface 2a, are located relative to each other on opposite sides of the plane passing through the center line of shafts 4, as shown for example in the embodiment according to FIG. 3. This ensures that the portion forming the support of side walls 2c of screen plates 2 extends sufficiently beyond (with respect to screen surface 2a) so that both blade elements 5a, 5b and 50a, 50b always have sufficient support formed by screen plates 2A in the longitudinal direction A of shaft 4 in order to create the above-mentioned longitudinal locking of shaft 4.

At the same time, however, it must be noted that the shaft slot of the screen plates 2, into which shafts 4 are fitted, is large enough or shaped in such a way that the screen plates 2 can be removed from the shafts without removing shaft or shafts 4.

1. A screening, crushing or mixing blade arrangement for heavy equipment, comprising:
a plurality of screen plates at a distance from each other and forming a screen surface provided with screen slots,
one or more non-circular rotatable shafts and power transmission members for rotating the shafts, wherein several replaceable, freely movable blades in the longitudinal direction of the shaft, are mounted directly on the shaft, the blades extending in a radial direction of the shaft outwards from the shaft through screen slots, the blades having a non-circular mounting hole essentially corresponding to the cross-section of the shaft,
wherein the blade is formed from two separate blade elements, wherein the first blade element and the second blade element of blade comprise respective installation openings opening outwards in a the radial direction of the mounting hole,
wherein the first blade element is dimensioned so that, when being installed, it can be brought to the desired location on the shaft through its installation opening and the second blade element can be brought onto the shaft from the opposite direction with respect to the first blade element next to the first blade element through its installation opening,
wherein the first blade element and the second blade element can be brought into alignment with each other in the longitudinal direction of shaft by a longitudinal movement of shaft, and
wherein the edges of the installation openings comprise pairs of locking designs forming the locking between the installed first blade element and the second blade element in the direction transverse to the longitudinal direction of the shaft.

2. The arrangement according to claim 1, wherein the blade part of the blade, which extends outwards from the shaft in the radial direction of shaft through screen slots, is present only in the first element.

3. The arrangement according to claim 1, wherein the blade part of the blade, which extends outwards from the shaft in the radial direction of the shaft through the screen slots ,is present in both blade elements.

4. The arrangement according to claim 3, wherein the blade forms a screening disk.

5. The arrangement according to the screen plates can be fixed in place on both sides of the blade, whereby the blade elements are locked in place also in the longitudinal direction of the shaft.

6. The arrangement according to claim 1, wherein an outer surface of the shaft and a corresponding inner surface of the mounting hole are configured so that the blade can be positioned in different angular positions relative to the shaft along the circumferential dimension of the shaft.

7. The arrangement according to claim 1, comprising adapters installed on the shaft between blades, the adapters having a corresponding discontinuous mounting hole in the circumferential direction.

8. The arrangement according to claim 7, arranged into a bucket of a heavy equipment.
